(19) United States
(12) Patent Application Publication
(10) Pub. No.: US 2013/0127787 A1
(43) Pub. Date: May 23, 2013

(54) TOUCH SCREEN PANEL AND DISPLAY APPARATUS HAVING THE SAME

(71) Applicant: SAMSUNG DISPLAY CO., LTD., Gyeonggi-do (KR)

(72) Inventors: Jong-Hee KIM, Gyeonggi-do (KR); Cheol-Gon KIM, Seoul (KR)

(73) Assignee: SAMSUNG DISPLAY CO., LTD., Gyeonggi-do (KR)

(21) Appl. No.: 13/658,559

(22) Filed: Oct. 23, 2012

(30) Foreign Application Priority Data
Nov. 23, 2011 (KR) 10-2011-0122717

(51) Int. Cl. G06F 3/042

(52) U.S. Cl. 345/175

(57) ABSTRACT

A touch screen panel includes a unit pixel and a light sensing part. The unit pixel is connected to an N-th gate line and an M-th data line. The light sensing part is adjacent to the unit pixel. The light sensing part includes a first sensing switching element and a second sensing switching element. The first sensing switching element includes a gate electrode connected to the N-th gate line, a drain electrode connected to a P-th read out line and a source electrode connected to a first node. The second sensing switching element includes a gate electrode to which a first voltage is applied, a drain electrode connected to the first node and a source electrode connected to an X-th gate line. N, M, P and X are positive integers. Thus, an aperture ratio of the touch screen panel can be improved.

### CROSS-REFERENCE TO RELATED APPLICATION

This application claims priority to Korean Patent Application No. 10-2011-0122717, filed on Nov. 23, 2011 pursuant to 35 U.S.C. §119, the contents of which are herein incorporated by reference in their entireties.

### TECHNICAL FIELD

Exemplary embodiments of the present invention relate to a touch screen panel and a display apparatus having the touch screen panel. More particularly, exemplary embodiments of the present invention relate to a touch screen panel including light sensing parts and a display apparatus having the touch screen panel.

### DISCUSSION OF THE RELATED ART

Display apparatuses including a touch screen panel have been widely used. Touch signals are inputted by touching the touch screen panel using a means, such as a stylus pen, a finger, and so on.

In such display apparatuses, a display panel may be disposed on the touch screen panel or may be integrally formed with the touch screen.

The touch screen panel may include unit pixels and light sensing parts. Each light sensing part includes a sensing switching element and signal lines through which signals are provided to the sensing switching element. The aperture ratio of the touch screen panel may be decreased due to the signal lines. In addition, a signal generating part that provides signals to the sensing switching elements is required, resulting in a more complicated structure of a driver for the touch screen panel.

### SUMMARY

Exemplary embodiments of the present invention provide a touch screen panel with an improved aperture ratio and a display apparatus having the touch screen panel.

In an exemplary embodiment of the present invention, a touch screen panel includes a unit pixel and a light sensing part. The unit pixel is connected to an N-th gate line and an M-th data line. The light sensing part is adjacent to the unit pixel. The light sensing part includes a first sensing switching element and a second sensing switching element. The first sensing switching element includes a gate electrode connected to the N-th gate line, a drain electrode connected to a P-th read out line and a source electrode connected to a first node. The second sensing switching element includes a gate electrode to which a first voltage is applied, a drain electrode connected to the first node and a source electrode connected to an X-th gate line. N, M, P and X are positive integers.

In an exemplary embodiment, the second sensing switching element includes an oxide semiconductor thin film transistor.

In an exemplary embodiment, the first voltage includes a pulse signal.

In an exemplary embodiment, the second sensing switching element includes an amorphous silicon thin film transistor.

In an exemplary embodiment, the light sensing part further includes a read out capacitor connected to the first node.

In an exemplary embodiment, X is less than N.

In an exemplary embodiment, the gate electrode of the second sensing switching element is connected to a Y-th gate line. Y is a positive integer different from X.

In an exemplary embodiment, Y is greater than N.

In an exemplary embodiment, the gate electrode of the second sensing switching element is connected to the X-th gate line.

In an exemplary embodiment, the unit pixel includes a first switching element, a second switching element and a third switching element. The first switching element is connected to the N-th gate line, the M-th data line and a first pixel electrode. The second switching element is connected to the N-th gate line, the M-th data line and a second pixel electrode. The third switching element includes a gate electrode connected to an N-th charge sharing gate line, a source electrode connected to a down capacitor and a drain electrode connected to the second pixel electrode.

In an exemplary embodiment, the gate electrode of the second sensing switching element is connected to the N-th charge sharing gate line. The N-th charge sharing gate line is connected to a Y-th gate line. Y is a positive integer different from X.

In an exemplary embodiment, the N-th charge sharing gate line is connected to the Y-th gate line at a peripheral region of the touch screen panel, the peripheral region displaying no image.

In an exemplary embodiment, the unit pixel includes a switching element including a gate electrode connected to the N-th gate line, a source electrode connected to the M-th data line, and a drain electrode connected to a first end of a liquid crystal capacitor and a first end of a storage capacitor. A common voltage is applied to a second end of the liquid crystal capacitor opposite to the first end of the liquid crystal capacitor. A storage voltage is applied to a second end of the storage capacitor opposite to the first end of the storage capacitor.

In an exemplary embodiment of the present invention, a display apparatus includes a touch screen panel, a gate driver, a data driver, and a touch determining part. The touch screen panel includes a unit pixel connected to an N-th gate line and an M-th data line and a light sensing part adjacent to the unit pixel and having a first sensing switching element and a second sensing switching element. The first sensing switching element includes a gate electrode connected to the N-th gate line, a drain electrode connected to a P-th read out line and a source electrode connected to a first node. The second sensing switching element includes a gate electrode to which a first voltage is applied, a drain electrode connected to the first node and a source electrode connected to an X-th gate line. The gate driver provides an N-th gate signal to the N-th gate line. The data driver provides an M-th data signal to the M-th data line. The touch determining part is connected to the P-th read out line to determine a touch on the touch screen panel. N, M, P and X are positive integers.

In an exemplary embodiment, the second sensing switching element includes an oxide semiconductor thin film transistor.

In an exemplary embodiment, the first voltage includes a pulse signal.

In an exemplary embodiment, the second sensing switching element includes an amorphous silicon thin film transistor.

In an exemplary embodiment, the light sensing part further includes a read out capacitor connected to the first node.

In an exemplary embodiment, the gate electrode of the second sensing switching element is connected to a Y-th gate line. Y is a positive integer different from X.

In an exemplary embodiment, the gate electrode of the second sensing switching element is connected to the X-th gate line.

In an exemplary embodiment, the unit pixel includes a first switching element, a second switching element, and a third switching element. The first switching element is connected to the N-th gate line, the M-th data line, and a first pixel electrode. The second switching element is connected to the N-th gate line, the M-th data line, and a second pixel electrode. The third switching element includes a gate electrode connected to an N-th charge sharing gate line, a source electrode connected to a down capacitor, and a drain electrode connected to the second pixel electrode.

In an exemplary embodiment, the gate electrode of the second sensing switching element is connected to the N-th charge sharing gate line. The N-th charge sharing gate line is connected to a Y-th gate line. Y is a positive integer different from X.

In an exemplary embodiment, the N-th charge sharing gate line is connected to the Y-th gate line at a peripheral region of the touch screen panel, the peripheral region displaying no image.

In an exemplary embodiment, the touch determining part is disposed in the data driver.

According to the embodiments of the present invention, an aperture ratio of the touch screen panel can be increased, and a structure of a driver of the touch screen panel can be simplified.

### BRIEF DESCRIPTION OF THE DRAWINGS

The embodiments of the present invention will become more apparent in the detailed description with reference to the accompanying drawings, in which:

FIG. 1 is a block diagram illustrating a display apparatus according to an exemplary embodiment of the present invention;

FIG. 2 is a circuit diagram illustrating a unit pixel and a light sensing part as shown in FIG. 1;

FIG. 3 is a timing diagram illustrating driving signals of a touch determining part and a gate driver as shown in FIG. 1;

FIG. 4 is a circuit diagram illustrating a unit pixel and a light sensing part according to an exemplary embodiment;

FIG. 5 is a circuit diagram illustrating a unit pixel and a light sensing part according to an exemplary embodiment;

FIG. 6 is a circuit diagram illustrating a unit pixel and a light sensing part according to an exemplary embodiment;

FIG. 7 is a circuit diagram illustrating a unit pixel and a light sensing part according to an exemplary embodiment;

FIG. 8 is a circuit diagram illustrating a unit pixel and a light sensing part according to an exemplary embodiment;

FIG. 9 is a circuit diagram illustrating a unit pixel and a light sensing part according to an exemplary embodiment;

FIG. 10 is a circuit diagram illustrating a unit pixel and a light sensing part according to an exemplary embodiment;

FIG. 11 is a circuit diagram illustrating a unit pixel and a light sensing part according to an exemplary embodiment;

FIG. 12 is a circuit diagram illustrating a unit pixel and a light sensing part according to an exemplary embodiment;

FIG. 13 is a circuit diagram illustrating a unit pixel and a light sensing part according to an exemplary embodiment;

FIG. 14 is a circuit diagram illustrating a unit pixel and a light sensing part according to an exemplary embodiment;

FIG. 15 is a circuit diagram illustrating a unit pixel and a light sensing part according to an exemplary embodiment;

FIG. 16 is a circuit diagram illustrating a unit pixel and a light sensing part according to an exemplary embodiment;

FIG. 17 is a circuit diagram illustrating a unit pixel and a light sensing part according to an exemplary embodiment; and

FIG. 18 is a circuit diagram illustrating a unit pixel and a light sensing part according to an exemplary embodiment.

### DETAILED DESCRIPTION OF EMBODIMENTS OF THE INVENTION

Hereinafter, exemplary embodiments of the present invention will be described in further detail with reference to the accompanying drawings, wherein the same reference numerals may be used to denote the same or substantially the same elements throughout the specification and the drawings. The present invention may be embodied in various different ways and should not be construed as limited to the exemplary embodiments described herein.

It will be understood that when an element or layer is referred to as being “on,” “connected to” or “coupled to” another element or layer, it can be directly on, connected or coupled to the other element or layer or intervening elements or layers may be present.

As used herein, the singular forms, “a,” “an” and “the” are intended to include the plural forms as well, unless the context clearly indicates otherwise.

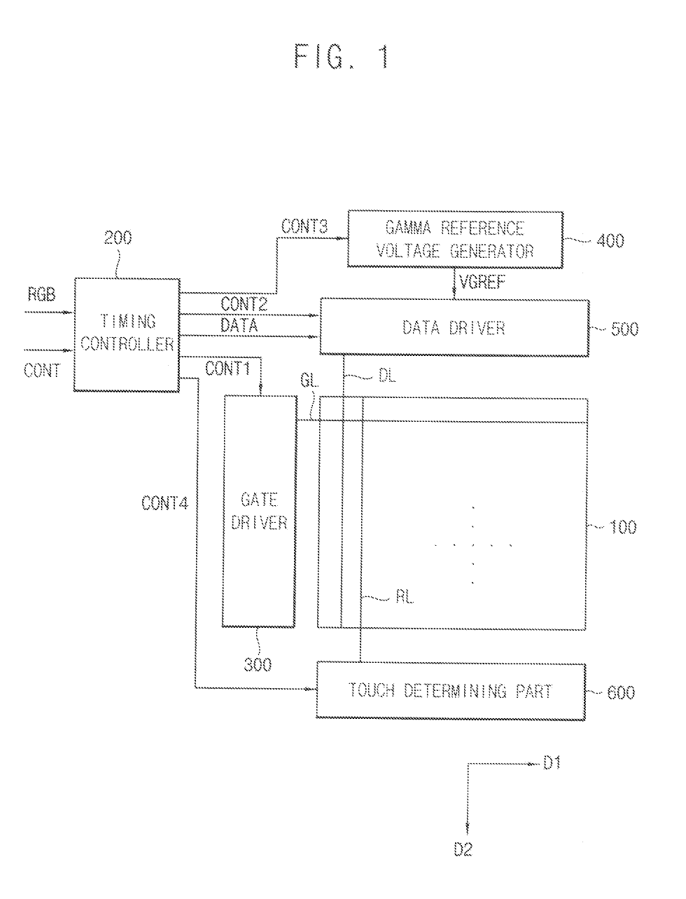

FIG. 1 is a block diagram illustrating a display apparatus according to an exemplary embodiment of the present invention.

Referring to FIG. 1, the display apparatus includes a touch screen panel 100 and a timing controller 200, a gate driver 300, a gamma reference voltage generator 400, a data driver 500 and a touch determining part 600.

The touch screen panel 100 includes a plurality of gate lines GL, a plurality of data lines DL and a plurality of unit pixels connected to the gate lines GL and the data lines DL. The gate lines GL extend in a first direction D1 and the data lines DL extend in a second direction D2 crossing the first direction D1.

Each unit pixel includes a switching element, a liquid crystal capacitor and a storage capacitor. The liquid crystal capacitor and the storage capacitor are electrically connected to the switching element. The unit pixels are disposed in a matrix form.

The touch screen panel 100 further includes a plurality of read out lines RL and a plurality of light sensing parts connected to the read out lines RL. The light sensing parts are adjacent to the unit pixels, respectively. The read out lines RL extend in the second direction D2.

The number of the light sensing parts is the same or substantially the same as the number of the unit pixels. Alternatively, the number of the light sensing parts is less than the number of the unit pixels. According to an embodiment, each light sensing part corresponds to several unit pixels.

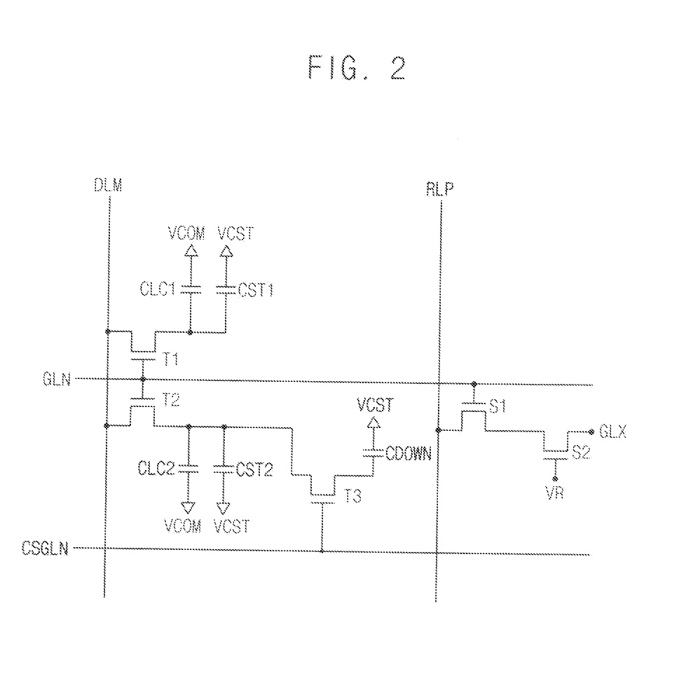

A structure of the unit pixel and the light sensing part is described in detail with reference to FIG. 2.

The timing controller 200 receives input image data RGB and input control signals CONT from an external apparatus (not shown). The input image data includes red image data R, green image data G and blue image data B. The input control signals CONT include a master clock signal and a data enable signal. According to an embodiment, the input control signals CONT further include a vertical synchronizing signal and a horizontal synchronizing signal.

The timing controller 200 generates a first control signal CONT1, a second control signal CONT2, a third control signal CONT3, a fourth control signal CONT40 and a data signal DATA based on the input image data RGB and the input control signals CONT.

The timing controller 200 generates the first control signal CONT1 for controlling an operation of the gate driver 300 based on the input control signals CONT and outputs the first control signal CONT1 to the gate driver 300. The first control signal CONT1 includes a vertical start signal and a gate clock signal.

The timing controller 200 generates the second control signal CONT2 for controlling an operation of the data driver 500 based on the input control signals CONT and outputs the second control signal CONT2 to the data driver 500. The second control signal CONT2 includes a horizontal start signal and a load signal.

The timing controller 200 generates the data signal DATA based on the input image data RGB. The timing controller 200 outputs the data signal DATA to the data driver 500.

The timing controller 200 generates the third control signal CONT3 for controlling an operation of the gamma reference voltage generator 400 based on the input control signals CONT and outputs the third control signal CONT3 to the gamma reference voltage generator 400.

The timing controller 200 generates the fourth control signal CONT4 for controlling an operation of the touch determining part 600 based on the input control signals CONT and outputs the fourth control signal CONT4 to the touch determining part 600.

The gate driver 300 generates gate signals, which drive the gate lines GL, in response to the first control signal CONT1 received from the timing controller 200. The gate driver 300 sequentially outputs the gate signals to the gate lines GL.

According to an embodiment, the gate driver 300 is directly mounted on the touch screen panel 100 or is connected to the touch screen panel 100 as a tape carrier package (TCP) type. Alternatively, the gate driver 300 is integrated on the touch screen panel 100.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA.

According to an embodiment, the gamma reference voltage generator 400 is disposed in the timing controller 200. Alternatively, the gamma reference voltage generator 400 is disposed in the data driver 500.

The data driver 500 receives the second control signal CONT2 and the data signal DATA from the timing controller 200 and receives the gamma reference voltages VGREF from the gamma reference voltage generator 400. The data driver 500 converts the data signal DATA into analog data voltages using the gamma reference voltages VGREF. The data driver 500 sequentially outputs the data voltages to the data lines DL.

The data driver 500 includes a shift register (not shown), a latch (not shown), a signal processing part (not shown) and a buffer part (not shown). The shift register outputs a latch pulse to the latch. The latch temporally stores the data signal DATA. The latch outputs the data signal DATA to the signal processing part. The signal processing part generates an analog data voltage based on the data signal of a digital type and the gamma reference voltage VGREF. The signal processing part outputs the data voltage to the buffer part. The buffer part compensates for the data voltage to have a uniform level. The buffer part outputs the compensated data voltage to the data line DL.

According to an embodiment, the data driver 500 is directly mounted on the touch screen panel 100 or is connected to the touch screen panel 100 in a TCP type. Alternatively, the data driver 500 is integrated on the touch screen panel 100.

The touch determining part 600 is connected to the light sensing parts through the read out lines RL. The touch determining part 600 senses touches through the read out lines RL in response to the fourth control signal CONT4 received from the timing controller 200.

According to an embodiment, the touch determining part 600 is disposed adjacent to a side portion of the touch screen panel 100 which is adjacent to the data driver 500. According to an embodiment, the touch determining part 600 is disposed in the data driver 500.

According to an embodiment, the display apparatus further includes a touch screen panel driver that provides driving voltages to the light sensing parts of the touch screen panel 100. The touch screen panel driver is disposed in the timing controller 200. Alternatively, the touch screen panel driver is disposed in the data driver 500.

FIG. 2 is a circuit diagram illustrating the unit pixel and the light sensing part of FIG. 1.

Referring to FIGS. 1 and 2, the unit pixel includes a first subpixel and a second subpixel. The first subpixel is an upper pixel. The second subpixel is a lower pixel.

The first subpixel includes a first switching element T1, a first liquid crystal capacitor CLC1 and a first storage capacitor CST1. The second subpixel includes a second switching element T2, a second liquid crystal capacitor CLC2, a second storage capacitor CST2 and a third switching element T3 and a down capacitor CDOWN.

According to an embodiment, each of the first to third switching elements T1 to T3 includes a thin film transistor (“TFT”). According to an embodiment, each of the first to third switching elements T1 to T3 includes an amorphous silicon TFT or an oxide semiconductor TFT.

The first switching element T1 is connected to an N-th gate line GLN, an M-th data line DLM and a first pixel electrode. Here, N and M are positive integers. A gate electrode of the first switching element T1 is connected to the N-th gate line GLN. A source electrode of the first switching element T1 is connected to the M-th data line DLM. A drain electrode of the first switching element T1 is connected to a first end of the first liquid crystal capacitor CLC1 and a first end of the first storage capacitor CST1. The first pixel electrode is disposed at the first end of the first liquid crystal capacitor CLC1. A common voltage VCOM is applied to a second end of the first liquid crystal capacitor CLC1 opposite to the first end of the first liquid crystal capacitor CLC1. A storage voltage VCST is applied to a second end of the first storage capacitor CST1 opposite to the first end of the first storage capacitor CST1. For example, according to an embodiment, the common voltage VCOM is the same or substantially equal to the storage voltage VCST.

The second switching element T2 is connected to the N-th gate line GLN, the M-th data line DLM and a second pixel electrode. A gate electrode of the second switching element T2 is connected to the N-th gate line GLN. A source electrode of the second switching element T2 is connected to the M-th data line DLM. A drain electrode of the second switching element T2 is connected to a first end of the second liquid crystal capacitor CLC2 and a first end of the second storage capacitor CST2. The second pixel electrode is disposed at the first end of the second liquid crystal capacitor CLC2. The common voltage VCOM is applied to a second end of the second liquid crystal capacitor CLC2 opposite to the first end of the second liquid crystal capacitor CLC2. The storage voltage VCST is applied to a second end of the second storage capacitor CST2 opposite to the first end of the second storage capacitor CST2.

A gate electrode of the third switching element T3 is connected to an N-th charge sharing gate line CSGLN. A source electrode of the third switching element T3 is connected to a first end of the down capacitor CDOWN. The storage voltage VCST is applied to a second end of the down capacitor CDOWN opposite to the first end of the down capacitor CDOWN. A drain electrode of the third switching element T3 is connected to the first end of the second liquid crystal capacitor CLC2 and the first end of the second storage capacitor CST2.

The N-th charge sharing gate line CSGLN is connected to one of the gate lines except for the N-th gate line GLN. According to an embodiment, the N-th charge sharing gate line CSGLN is connected to one of gate lines after the N-th gate line. For example, according to an embodiment, the N-th charge sharing gate line CSGLN is connected to an (N+1)-th gate line.

The N-th charge sharing gate line CSGLN is connected to one of the gate lines except for the N-th gate line GLN at a peripheral region of the touch screen panel 100, the peripheral region displaying no image.

In an exemplary embodiment, at least one of the first and second storage capacitors CST1 and CST2 is omitted.

The light sensing part includes a first sensing switching element S1 and a second sensing switching element S2. According to an embodiment, the second sensing switching element S2 includes a photo transistor which senses light. The first sensing switching element S1 transmits a sensed signal to the touch determining part 600 through a P-th read out line RLP. Here, P is a positive integer.

According to an embodiment, each of the first and second sensing switching elements S1 and S2 includes a TFT. According to an embodiment, the first sensing switching element S1 includes an amorphous silicon TFT or an oxide semiconductor TFT. According to an exemplary embodiment, the second sensing switching element S2 includes an oxide semiconductor TFT. According to an embodiment, the light sensing part includes no storage capacitor due to a self capacitance characteristic of the second sensing switching element S2 which is an oxide semiconductor TFT.

For example, according to an embodiment, the second sensing switching element S2 includes at least one of zinc oxide, tin oxide, gallium indium zinc (Ga—In—Zn) oxide, indium zinc (In—Zn) oxide, indium tin (In—Sn) oxide, or indium tin zinc (In—Sn—Zn) oxide. According to an embodiment, the second sensing switching element S2 includes an oxide semiconductor doped with a metal such as aluminum (Al), nickel (Ni), copper (Cu), tantalum (Ta), molybdenum (Mo), hafnium (Hf), titanium (Ti), niobium (Nb), chromium Cr, or tungsten (W). The embodiments of the present invention are not limited to the above-listed material of the oxide semiconductor.

A gate electrode of the first sensing switching element S1 is connected to the N-th gate line GLN. A source electrode of the first sensing switching element is connected to a drain electrode of the second sensing switching element S2. A drain electrode of the first sensing switching element S1 is connected to the P-th read out line RLP.

Due to the self capacitance characteristic of the second sensing switching element S2, the second sensing switching element S2 maintains a turned-on state after a current passing through the second sensing switching element S2 is read out. According to an embodiment, a reset voltage VR that turns off the second sensing switching element S2 is applied to the second sensing switching element S2.

The reset voltage VR is applied to a gate electrode of the second sensing switching element S2. The reset voltage VR includes a pulse signal.

A source electrode of the second sensing switching element S2 is connected to an X-th gate line GLX. An X-th gate signal is applied through the X-th gate line GLX to the source electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

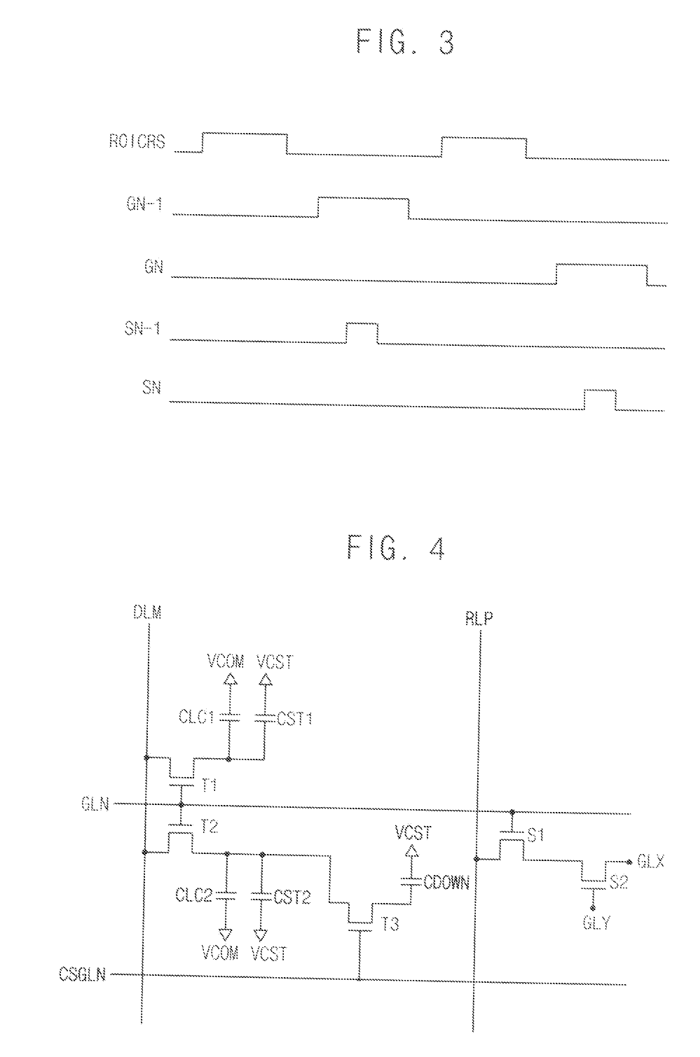

FIG. 3 is a timing diagram illustrating driving signals of the touch determining part 600 and the gate driver 400.

Referring to FIGS. 1 to 3, ROICRS is a signal to reset the touch determining part 600. GN−1 is an (N−1)-th gate signal applied to an (N−1)-th gate line. GN is an N-th gate signal applied to N-th gate line. SN−1 is a sensing signal to sense a current passing through the read out line corresponding to the (N−1)-th gate signal GN−1. SN is a sensing signal to sense a current passing through the read out line corresponding to the N-th gate signal GN.

SN−1 has a timing corresponding to a timing of GN−1. As shown in FIG. 3, the high duration of SN−1 is included in the high duration of GN−1. SN has a timing corresponding to a timing of GN. The high duration of SN is included in the high duration of GN.

For example, when the N-th gate signal GN−1 rises to a high status, the first sensing switching element S1 is turned on. After the first sensing switching element S1 is turned on, the touch determining part 600 senses the current flowing through the P-th read out line RLP in response to SN−1 so that the touch determining part 600 determines whether there is a touch on the unit pixel.

According to an exemplary embodiment, the X-th gate signal is applied to the source electrode of the second sensing switching element S2 so that no additional source voltage for sensing light is needed. As a consequence, the driver of the touch screen panel 100 can be simplified.

The source electrode of the second sensing switching element S2 is connected to the X-th gate line so that no additional signal line to apply the source voltage to the second sensing switching element S2 is needed. As a result, an aperture ratio of the touch screen panel 100 can be increased.

FIG. 4 is a circuit diagram illustrating a unit pixel and a light sensing part according to an exemplary embodiment.

The display apparatus described in connection with FIG. 4 is the same or substantially the same as the display apparatus described referring to FIGS. 1 to 3 except that the gate electrode of the second sensing switching element S2 is connected to a Y-th gate line GLY.

Referring to FIGS. 1 and 4, the light sensing part includes a first sensing switching element S1 and a second sensing switching element S2. According to an embodiment, the second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

A gate electrode of the first sensing switching element S1 is connected to an N-th gate line GLN. A source electrode of the first sensing switching element is connected to a drain electrode of the second sensing switching element S2. A drain electrode of the first sensing switching element S1 is connected to the P-th read out line RLP.

A gate electrode of the second sensing switching element S2 is connected to a Y-th gate line GLY. A Y-th gate signal is applied through the Y-th gate line GLY to the gate electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

A source electrode of the second sensing switching element S2 is connected to an X-th gate line GLX. An X-th gate signal is applied through the X-th gate line GLX to the source electrode of the second sensing switching element S2. Here, X is a positive integer different from N and Y. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing a light is needed. As a consequence, the driver of the touch screen panel 100 can be simplified.

The gate electrode of the second sensing switching element S2 is connected to the Y-th gate line and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be increased.

FIG. 5 is a circuit diagram illustrating a unit pixel and a light sensing part according to an exemplary embodiment.

The display apparatus described in connection with FIG. 5 is the same or substantially the same as the display apparatus described referring to FIG. 4 except that the gate electrode of the second sensing switching element S2 is connected to the charge sharing gate line.

Referring to FIGS. 1 and 5, the light sensing part includes a first sensing switching element S1 and a second sensing switching element S2. According to an embodiment, the second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

A gate electrode of the first sensing switching element S1 is connected to an N-th gate line GLN. A source electrode of the first sensing switching element is connected to a drain electrode of the second sensing switching element S2. A drain electrode of the first sensing switching element S1 is connected to the P-th read out line RLP.

A gate electrode of the second sensing switching element S2 is connected to an N-th charge sharing gate line CSGLN. The N-th charge sharing gate line CSGLN is connected to a Y-th gate line GLY. Thus, a Y-th gate signal is applied through the Y-th gate line GLY to the gate electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

The N-th charge sharing gate line CSGLN is connected to the Y-th gate line GLY at a peripheral region of the touch screen panel 100, the peripheral region displaying no image.

A source electrode of the second sensing switching element S2 is connected to an X-th gate line GLX. An X-th gate signal applied to the X-th gate line GLX is applied to the source electrode of the second sensing switching element S2. Here, X is a positive integer different from N and Y. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing light is needed. As a consequence, the driver of the touch screen panel 100 can be simplified.

The gate electrode of the second sensing switching element S2 is connected to the N-th charge sharing gate line CSGLN and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be increased.

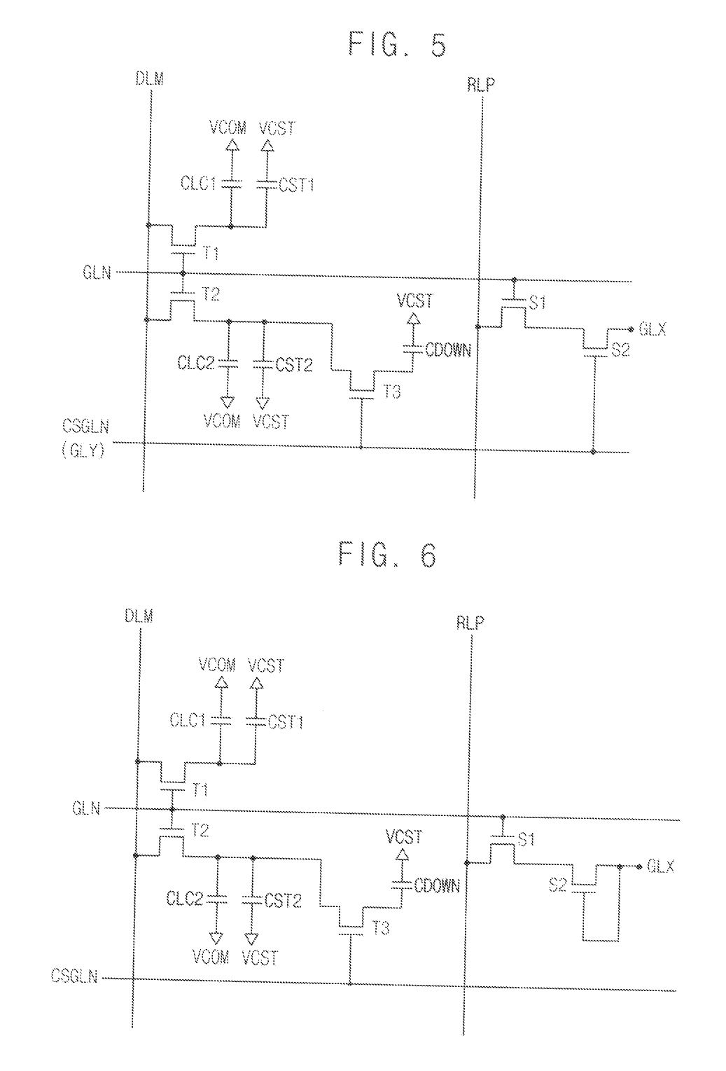

FIG. 6 is a circuit diagram illustrating a unit pixel and a light sensing part according to an exemplary embodiment.

The display apparatus described in connection with FIG. 6 is the same or substantially the same as the display apparatus described referring to FIGS. 1 to 3 except that the gate electrode of the second sensing switching element S2 is connected to the X-th gate line.

Referring to FIGS. 1 and 6, the light sensing part includes a first sensing switching element S1 and a second sensing switching element S2. According to an embodiment, the second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

A gate electrode of the first sensing switching element S1 is connected to an N-th gate line GLN. A source electrode of the first sensing switching element is connected to a drain electrode of the second sensing switching element S2. A drain electrode of the first sensing switching element S1 is connected to the P-th read out line RLP.

A gate electrode and a source electrode of the second sensing switching element S2 are connected to an X-th gate line GLX. An X-th gate signal is applied through the X-th gate line GLX to the gate electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the X-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

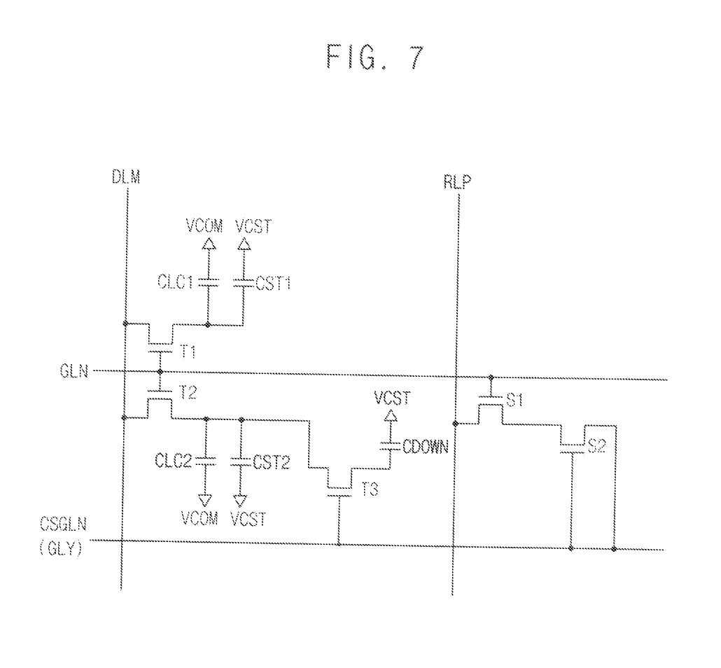

FIG. 7 is a circuit diagram illustrating a unit pixel and a light sensing part according to an exemplary embodiment.

The display apparatus described in connection with FIG. 7 is the same or substantially the same as the display apparatus described referring to FIG. 6 except that the gate electrode and the source electrode of the second sensing switching element S2 is connected to the charge sharing gate line.

Referring to FIGS. 1 and 7, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

A gate electrode of the first sensing switching element S1 is connected to an N-th gate line GLN. A source electrode of the first sensing switching element is connected to a drain electrode of the second sensing switching element S2. A drain electrode of the first sensing switching element S1 is connected to the P-th read out line RLP.

A gate electrode and a source electrode of the second sensing switching element S2 are connected to an N-th charge sharing gate line CSGLN. The N-th charge sharing gate line CSGLN is connected to a Y-th gate line GLY. Thus, a Y-th gate signal is applied through the Y-th gate line GLY to the gate electrode and the source electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

The N-th charge sharing gate line CSGLN is connected to the Y-th gate line GLY at a peripheral region of the touch screen panel 100, the peripheral region displaying no image.

The drain electrode of the second sensing switching element S2 is connected to the source electrode of the first sensing switching element S1.

According to an exemplary embodiment, the Y-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 are connected to the N-th charge sharing gate line CSGLN so that no additional signal lines to apply the reset voltage and the source voltage to the second sensing switching element S2 are needed. As a result, an aperture ratio of the touch screen panel 100 can be improved.

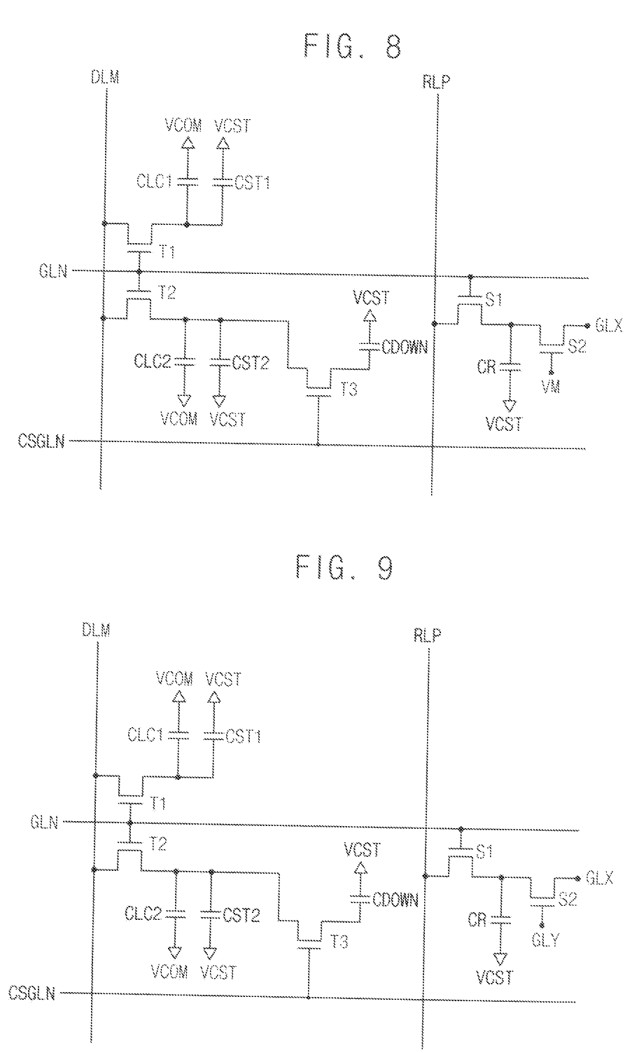

FIG. 8 is a circuit diagram illustrating a unit pixel and a light sensing part according to an exemplary embodiment.

The display apparatus described in connection with FIG. 8 is the same or substantially the same as the display apparatus described referring to FIGS. 1 to 3 except that the second sensing switching element S2 includes an amorphous silicon TFT and the light sensing part further includes a read out storage capacitor.

Referring to FIGS. 1 and 8, the light sensing part includes a first sensing switching element S1 and a second sensing switching element S2. The second sensing switching element S2 includes a photo transistor which senses light. The first sensing switching element 51 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A maintaining voltage VM is applied to a gate electrode of the second sensing switching element S2 and maintains a turned-off state of the second sensing switching element S2. According to an embodiment, the maintaining voltage VM includes a direct current (“DC”) voltage. Alternatively, the maintaining voltage VM includes a pulse signal.

A source electrode of the second sensing switching element S2 is connected to an X-th gate line GLX. An X-th gate signal is applied through the X-th gate line GLX to the source electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the X-th gate signal is applied to the source electrode of the second sensing switching element S2 so that no additional source voltage for sensing light is needed. As a consequence, the driver of the touch screen panel 100 can be simplified.

The source electrode of the second sensing switching element S2 is connected to the X-th gate line so that no additional signal line to apply the source voltage to the second sensing switching element S2 is needed. As a result, an aperture ratio of the touch screen panel 100 can be improved.

FIG. 9 is a circuit diagram illustrating a unit pixel and a light sensing part according to an exemplary embodiment.

The display apparatus described in connection with FIG. 9 is the same or substantially the same as the display apparatus described referring to FIG. 4 except that the second sensing switching element S2 includes an amorphous silicon TFT and the light sensing part further includes a read out storage capacitor.

Referring to FIGS. 1 and 9, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP.

Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode of the second sensing switching element S2 is connected to a Y-th gate line GLY. A Y-th gate signal applied to the Y-th gate line GLY is applied to the gate electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

A source electrode of the second sensing switching element S2 is connected to an X-th gate line GLX. An X-th gate signal applied to the X-th gate line GLX is applied to the source electrode of the second sensing switching element S2. Here, X is a positive integer different from N and Y. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing light is needed. As a consequence, the driver of the touch screen panel 100 can be simplified.

The gate electrode of the second sensing switching element S2 is connected to the Y-th gate line and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

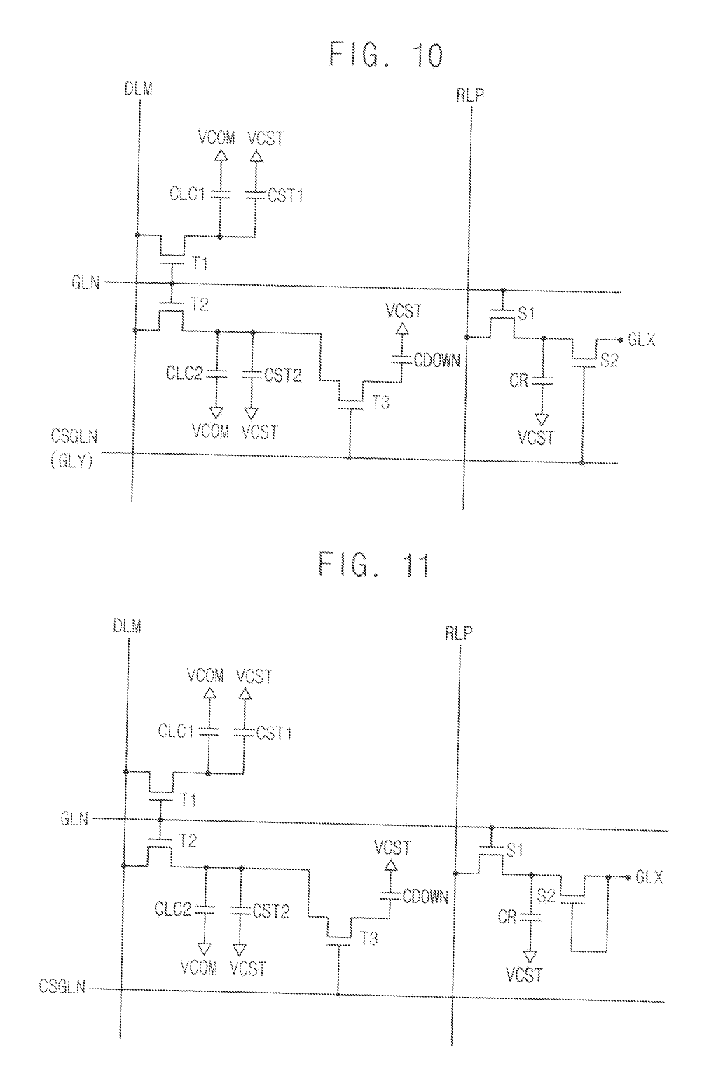

FIG. 10 is a circuit diagram illustrating a unit pixel and a light sensing part according to an exemplary embodiment.

The display apparatus described in connection with FIG. 10 is the same or substantially the same as the display apparatus described referring to FIG. 5 except that the second sensing switching element S2 includes an amorphous silicon TFT and the light sensing part further includes a read out storage capacitor.

Referring to FIGS. 1 and 10, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode of the second sensing switching element S2 is connected to an N-th charge sharing gate line CSGLN. The N-th charge sharing gate line CSGLN is connected to a Y-th gate line GLY. Thus, a Y-th gate signal is applied through the Y-th gate line GLY to the gate electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

The N-th charge sharing gate line CSGLN is connected to the Y-th gate line GLY at a peripheral region of the touch screen panel 100, the peripheral region displaying no image.

A source electrode of the second sensing switching element S2 is connected to an X-th gate line GLX. An X-th gate signal is applied through the X-th gate line GLX to the source electrode of the second sensing switching element S2. Here, X is a positive integer different from N and Y. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing light is needed. As a consequence, the driver of the touch screen panel 100 can be simplified.

The gate electrode of the second sensing switching element S2 is connected to the N-th charge sharing gate line CSGLN and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

FIG. 11 is a circuit diagram illustrating a unit pixel and a light sensing part according to an exemplary embodiment.

The display apparatus described in connection with FIG. 11 is the same or substantially the same as the display apparatus described referring to FIG. 6 except that the second sensing switching element S2 includes an amorphous silicon TFT and the light sensing part further includes a read out storage capacitor.

Referring to FIGS. 1 and 11, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode and a source electrode of the second sensing switching element S2 are connected to an X-th gate line GLX. An X-th gate signal is applied through the X-th gate line GLX to the gate electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the X-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

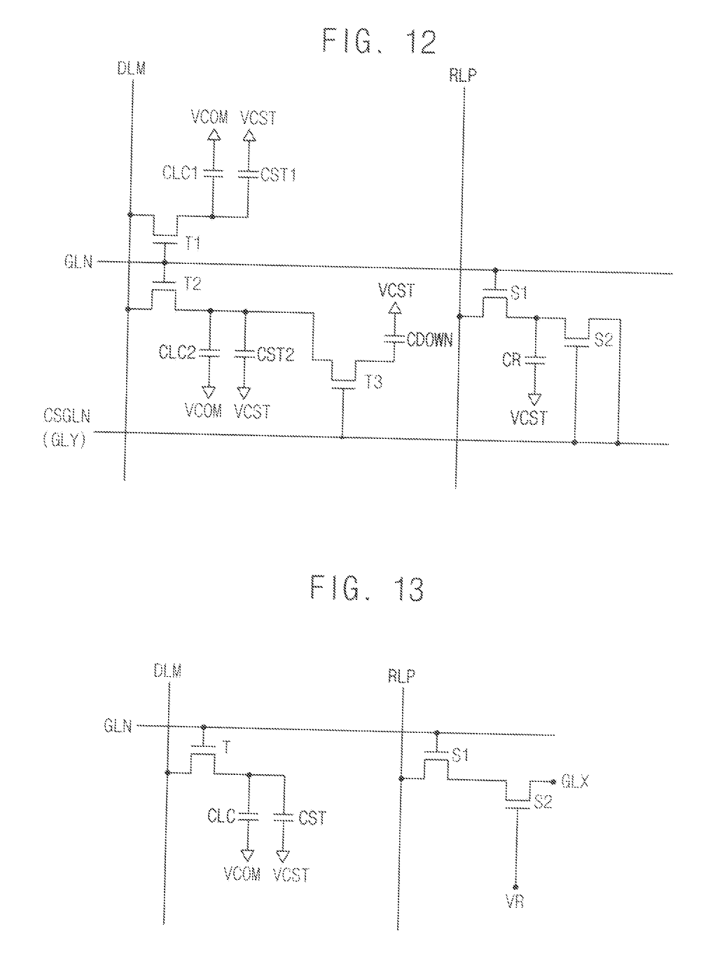

FIG. 12 is a circuit diagram illustrating a unit pixel and a light sensing part according to an exemplary embodiment.

The display apparatus described in connection with FIG. 12 is the same or substantially the same as the display apparatus described referring to FIG. 7 except that the second sensing switching element S2 includes an amorphous silicon TFT and the light sensing part further includes a read out storage capacitor.

Referring to FIGS. 1 and 12, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode and a source electrode of the second sensing switching element S2 are connected to an N-th charge sharing gate line CSGLN. The N-th charge sharing gate line CSGLN is connected to a Y-th gate line GLY. Thus, a Y-th gate signal is applied through the Y-th gate line GLY to the gate electrode and the source electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

The N-th charge sharing gate line CSGLN is connected to the Y-th gate line GLY at a peripheral region of the touch screen panel 100, the peripheral region displaying no image.

The drain electrode of the second sensing switching element S2 is connected to the source electrode of the first sensing switching element S1.

According to an exemplary embodiment, the Y-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 are connected to the N-th charge sharing gate line CSGLN so that no additional signal lines to apply the reset voltage and the source voltage to the second sensing switching element S2 are needed. As a result, an aperture ratio of the touch screen panel 100 is improved.

FIG. 13 is a circuit diagram illustrating a unit pixel and a light sensing part according to an exemplary embodiment.

The display apparatus described in connection with FIG. 13 is the same or substantially the same as the display apparatus described referring to FIGS. 1 to 3 except for a structure of the unit pixel.

Referring to FIGS. 1 and 13, the unit pixel includes a switching element T, a liquid crystal capacitor CLC and a storage capacitor CST.

The switching element T includes a TFT. The switching element T includes an amorphous silicon TFT or an oxide semiconductor TFT.

The switching element T is connected to an N-th gate line GLN, an M-th data line DLM and a pixel electrode. A gate electrode of the switching element T is connected to the N-th gate line GLN. A source electrode of the switching element T is connected to the M-th data line DLM. A drain electrode of the switching element T is connected to a first end of the liquid crystal capacitor CLC and a first end of the storage capacitor CST. The pixel electrode is disposed at the first end of the liquid crystal capacitor CLC. A common voltage VCOM is applied to a second end of the liquid crystal capacitor CLC opposite to the first end of the liquid crystal capacitor CLC. A storage voltage VCST is applied to a second end of the storage capacitor CST opposite to the first end of the storage capacitor CST. For example, the common voltage VCOM is the same or substantially equal to the storage voltage VCST.

The light sensing part includes a first sensing switching element S1 and a second sensing switching element S2.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

According to an exemplary embodiment, the X-th gate signal is applied to the source electrode of the second sensing switching element S2 so that no additional source voltage for sensing light is needed. As a consequence, the driver of the touch screen panel 100 can be simplified.

The source electrode of the second sensing switching element S2 is connected to the X-th gate line so that no additional signal line to apply the source voltage to the second sensing switching element S2 is needed. As a result, an aperture ratio of the touch screen panel 100 can be improved.

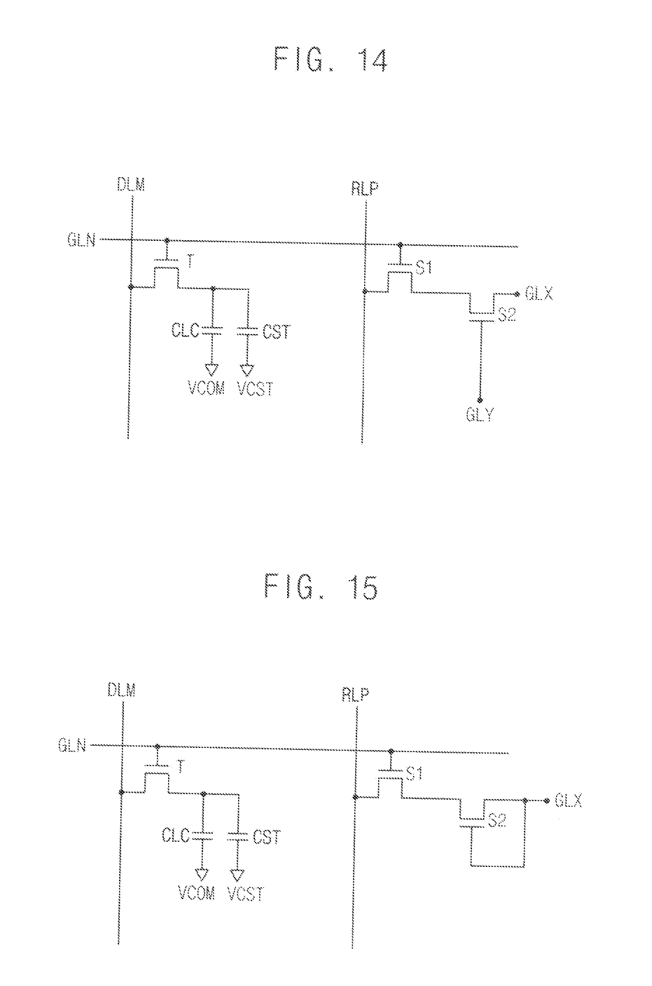

FIG. 14 is a circuit diagram illustrating a unit pixel and a light sensing part according to an exemplary embodiment.

The display apparatus described in connection with FIG. 14 is the same or substantially the same as the display apparatus described referring to FIG. 4 except for a structure of the unit pixel.

Referring to FIGS. 1 and 14, the unit pixel includes a switching element T, a liquid crystal capacitor CLC and a storage capacitor CST.

The switching element T includes a TFT. The switching element T includes an amorphous silicon TFT or an oxide semiconductor TFT.

The switching element T is connected to an N-th gate line GLN, an M-th data line DLM and a pixel electrode. A gate electrode of the switching element T is connected to the N-th gate line GLN. A source electrode of the switching element T is connected to the M-th data line DLM. A drain electrode of the switching element T is connected to a first end of the liquid crystal capacitor CLC and a first end of the storage capacitor CST. The pixel electrode is disposed at the first end of the liquid crystal capacitor CLC. A common voltage VCOM is applied to a second end of the liquid crystal capacitor CLC opposite to the first end of the liquid crystal capacitor CLC. A storage voltage VCST is applied to a second end of the storage capacitor CST opposite to the first end of the storage capacitor CST. For example, according to an embodiment, the common voltage VCOM is the same or substantially equal to the storage voltage VCST.

The light sensing part includes a first sensing switching element S1 and a second sensing switching element S2.

According to an exemplary embodiment, the second sensing switching element S2 is an oxide semiconductor TFT. According to an embodiment, the light sensing part includes no storage capacitor due to a self capacitance characteristic of the second sensing switching element S2 which is the oxide semiconductor TFT.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing light is needed. As a consequence, the driver of the touch screen panel 100 can be simplified.

The gate electrode of the second sensing switching element S2 is connected to the Y-th gate line and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

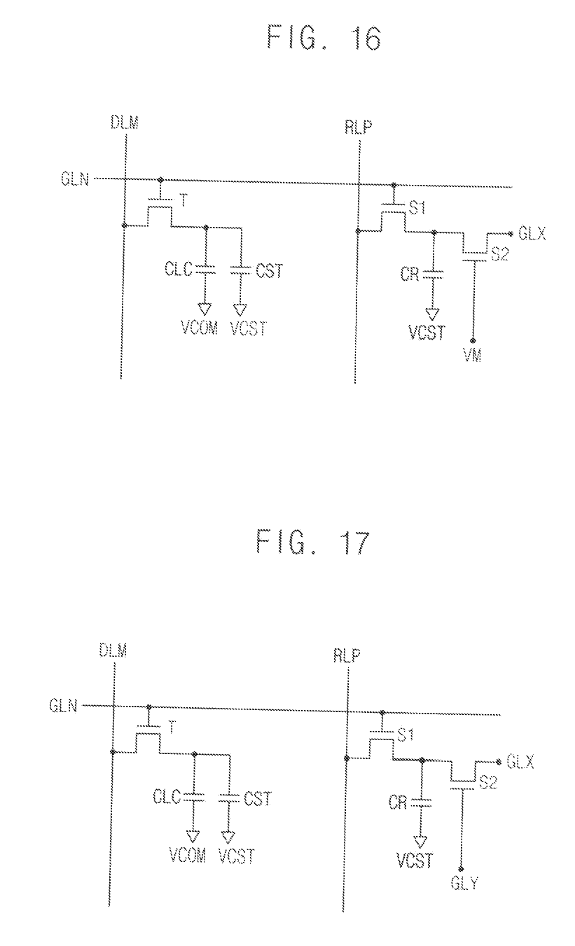

FIG. 15 is a circuit diagram illustrating a unit pixel and a light sensing part according to an exemplary embodiment.

The display apparatus described in connection with FIG. 15 is the same or substantially the same as the display apparatus described referring to FIG. 6 except for a structure of the unit pixel.

Referring to FIGS. 1 and 15, the unit pixel includes a switching element T, a liquid crystal capacitor CLC and a storage capacitor CST.

The switching element T includes a TFT. The switching element T includes an amorphous silicon TFT or an oxide semiconductor TFT.

The switching element T is connected to an N-th gate line GLN, an M-th data line DLM and a pixel electrode. A gate electrode of the switching element T is connected to the N-th gate line GLN. A source electrode of the switching element T is connected to the M-th data line DLM. A drain electrode of the switching element T is connected to a first end of the liquid crystal capacitor CLC and a first end of the storage capacitor CST. The pixel electrode is disposed at the first end of the liquid crystal capacitor CLC. A common voltage VCOM is applied to a second end of the liquid crystal capacitor CLC opposite to the first end of the liquid crystal capacitor CLC. A storage voltage VCST is applied to a second end of the storage capacitor CST opposite to the first end of the storage capacitor CST. For example, according to an embodiment, the common voltage VCOM is the same or substantially equal to the storage voltage VCST.

The light sensing part includes a first sensing switching element S1 and a second sensing switching element S2.

According to an exemplary embodiment, the second sensing switching element S2 includes an oxide semiconductor TFT. According to an embodiment, the light sensing part includes no storage capacitor due to a self capacitance characteristic of the second sensing switching element S2 which is the oxide semiconductor TFT.

According to an exemplary embodiment, the X-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

FIG. 16 is a circuit diagram illustrating a unit pixel and a light sensing part according to an exemplary embodiment.

The display apparatus described in connection with FIG. 16 is the same or substantially the same as the display apparatus described referring to FIG. 13 except that the second sensing switching element S2 includes an amorphous silicon TFT and the light sensing part further includes a read out storage capacitor.

Referring to FIGS. 1 and 16, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A maintaining voltage VM is applied to a gate electrode of the second sensing switching element S2 and maintains a turned-off state of the second sensing switching element S2. According to an embodiment, the maintaining voltage VM includes a direct current (“DC”) voltage. Alternatively, the maintaining voltage VM may include a pulse signal.

A source electrode of the second sensing switching element S2 is connected to an X-th gate line GLX. An X-th gate signal is applied through the X-th gate line GLX to the source electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the X-th gate signal is applied to the source electrode of the second sensing switching element S2 so that no additional source voltage for sensing light is needed. As a consequence, the driver of the touch screen panel 100 can be simplified.

The source electrode of the second sensing switching element S2 is connected to the X-th gate line so that no additional signal line to apply the source voltage to the second sensing switching element S2 is needed. As a result, an aperture ratio of the touch screen panel 100 can be improved.

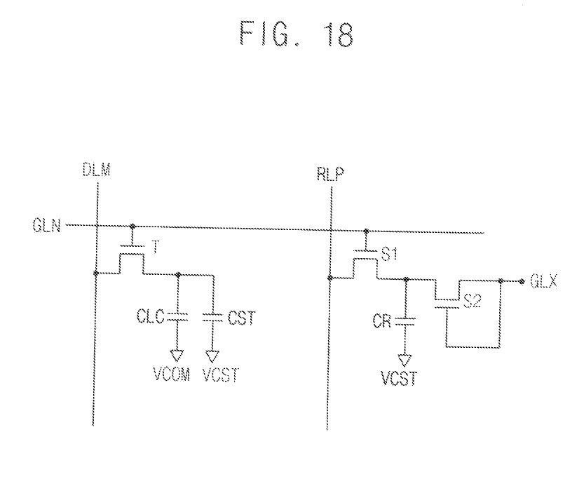

FIG. 17 is a circuit diagram illustrating a unit pixel and a light sensing part according to an exemplary embodiment.

The display apparatus described in connection with FIG. 17 is the same or substantially the same as the display apparatus described referring to FIG. 14 except that the second sensing switching element S2 includes an amorphous silicon TFT and the light sensing part further includes a read out storage capacitor.

Referring to FIGS. 1 and 17, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode of the second sensing switching element S2 is connected to a Y-th gate line GLY A Y-th gate signal is applied through the Y-th gate line GLY to the gate electrode of the second sensing switching element S2. According to an embodiment, the Y-th gate signal includes a pulse signal. Here, Y is a positive integer different from N. For example, according to an embodiment, Y is greater than N. For example, according to an embodiment, Y is N+1. Alternatively, Y is less than N.

A source electrode of the second sensing switching element S2 is connected to an X-th gate line GLX. An X-th gate signal applied to the X-th gate line GLX is applied to the source electrode of the second sensing switching element S2. Here, X is a positive integer different from N and Y. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the Y-th gate signal is applied to the gate electrode of the second sensing switching element S2 and the X-th gate signal is applied to the source electrode of the second sensing switching element S2 so that neither an additional reset voltage nor an additional source voltage for sensing light is needed. As a consequence, the driver of the touch screen panel 100 can be simplified.

The gate electrode of the second sensing switching element S2 is connected to the Y-th gate line and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

FIG. 18 is a circuit diagram illustrating a unit pixel and a light sensing part according to an exemplary embodiment.

The display apparatus described in connection with FIG. 18 is the same or substantially the same as the display apparatus described referring to FIG. 15 except that the second sensing switching element S2 includes an amorphous silicon TFT and the light sensing part further includes a read out storage capacitor.

Referring to FIGS. 1 and 18, the light sensing part includes a first sensing switching element S1 and a second sensing switching element S2. The second sensing switching element S2 includes a photo transistor which senses light. The first sensing switching element S1 transmits a sensed signal to the touch determining part 600 through a P-th read out line RLP. Here, P is a positive integer.

According to an exemplary embodiment, the second sensing switching element S2 includes an amorphous silicon TFT. The light sensing part further includes a read out storage capacitor CR. The read out storage capacitor CR maintains a signal sensed at the second sensing switching element S2 when the signal is read out.

A first end of the read out storage capacitor CR is connected to a source electrode of the first sensing switching element S1 and a drain electrode of the second sensing switching element S2. A storage voltage VCST is applied to a second end of the read out storage capacitor CR opposite to the first end of the read out storage capacitor CR. Alternatively, a common voltage VCOM is applied to the second end of the read out storage capacitor CR.

A gate electrode and a source electrode of the second sensing switching element S2 are connected to an X-th gate line GLX. An X-th gate signal is applied through the X-th gate line GLX to the gate electrode of the second sensing switching element S2. Here, X is a positive integer different from N. For example, according to an embodiment, X is less than N. For example, according to an embodiment, X is N−1. Alternatively, X is greater than N.

The drain electrode of the second sensing switching element S2 is connected to the source electrode of the first sensing switching element S1.

According to an exemplary embodiment, the X-th gate signal is applied to the gate electrode and the source electrode of the second sensing switching element S2 so that neither an additional reset voltage nor an additional source voltage for sensing light is needed. As a consequence, the driver of the touch screen panel 100 can be simplified.

The gate electrode and the source electrode of the second sensing switching element S2 is connected to the X-th gate line so that no additional signal lines to apply the reset voltage and the source voltage to the second sensing switching element S2 are needed. As a result, an aperture ratio of the touch screen panel 100 can be improved.

According to the embodiments of the present invention, an aperture ratio of the touch screen panel can be improved, and a structure of the driver of the touch screen panel can be simplified.

The foregoing is illustrative of the embodiments of the present invention and is not to be construed as limiting thereof. Although a few example embodiments of the present invention have been described, those skilled in the art will readily appreciate that many modifications are possible in the example embodiments. Accordingly, all such modifications are intended to be included within the scope of the embodiments of the present invention as defined in the claims.

What is claimed is:

1. A touch screen panel comprising:
a unit pixel connected to an N-th gate line and an M-th data line; and
a light sensing part adjacent to the unit pixel and including a first sensing switching element and a second sensing switching element, wherein the first sensing switching element includes a gate electrode connected to the N-th gate line, a drain electrode connected to a P-th read out line, and a source electrode connected to a first node, and wherein the second sensing switching element includes a gate electrode to which a first voltage is applied, a drain electrode connected to the first node, and a source electrode connected to an X-th gate line, wherein N, M, P, and X are positive integers.

2. The touch screen panel of claim 1, wherein the second sensing switching element includes an oxide semiconductor thin film transistor.

3. The touch screen panel of claim 2, wherein the first voltage includes a pulse signal.

4. The touch screen panel of claim 1, wherein the second sensing switching element includes an amorphous silicon thin film transistor.

5. The touch screen panel of claim 4, wherein the light sensing part further comprises a read out capacitor connected to the first node.

6. The touch screen panel of claim 1, wherein X is less than N.

7. The touch screen panel of claim 1, wherein the gate electrode of the second sensing switching element is connected to a Y-th gate line, wherein Y is a positive integer different from X.

8. The touch screen panel of claim 7, wherein Y is greater than N.

9. The touch screen panel of claim 1, wherein the gate electrode of the second sensing switching element is connected to the X-th gate line.

10. The touch screen panel of claim 1, wherein the unit pixel comprises:
a first switching element connected to the N-th gate line, the M-th data line, and a first pixel electrode;
a second switching element connected to the N-th gate line, the M-th data line, and a second pixel electrode; and
a third switching element including a gate electrode connected to an N-th charge sharing gate line, a source electrode connected to a down capacitor, and a drain electrode connected to the second pixel electrode.

11. The touch screen panel of claim 10, wherein the gate electrode of the second sensing switching element is connected to the N-th charge sharing gate line connected to a Y-th gate line, wherein Y is a positive integer different from X.

12. The touch screen panel of claim 11, wherein the N-th charge sharing gate line is connected to the Y-th gate line at a peripheral region of the touch screen panel.

13. The touch screen panel of claim 1, wherein the unit pixel comprises a switching element including a gate electrode connected to the N-th gate line, a source electrode connected to the M-th data line, and a drain electrode connected to a first end of a liquid crystal capacitor and a first end of a storage capacitor, wherein a common voltage is applied to a second end of the liquid crystal capacitor, and wherein a storage voltage is applied to a second end of the storage capacitor.

14. A display apparatus comprising:
a touch screen panel including a unit pixel and a light sensing part, wherein the unit pixel is connected to an N-th gate line and an M-th data line and wherein the light sensing part is adjacent to the unit pixel and has a first sensing switching element and a second sensing switching element, the first sensing switching element including a gate electrode connected to the N-th gate line, a drain electrode connected to a P-th read out line, and a source electrode connected to a first node, the second sensing switching element including a gate electrode to which a first voltage is applied, a drain electrode connected to the first node, and a source electrode connected to an X-th gate line;
a gate driver configured to provide an N-th gate signal to the N-th gate line;
a data driver configured to provide an M-th data signal to the M-th data line; and
a touch determining part connected to the P-th read out line, wherein N, M, P, and X are positive integers.

15. The display apparatus of claim 14, wherein the second sensing switching element includes an oxide semiconductor thin film transistor.

16. The display apparatus of claim 15, wherein the first voltage includes a pulse signal.

17. The display apparatus of claim 14, wherein the second sensing switching element includes an amorphous silicon thin film transistor.

18. The display apparatus of claim 17, wherein the light sensing part further comprises a read out capacitor connected to the first node.

19. The display apparatus of claim 14, wherein the gate electrode of the second sensing switching element is connected to a Y-th gate line, wherein Y is a positive integer different from X.

20. The display apparatus of claim 14, wherein the gate electrode of the second sensing switching element is connected to the X-th gate line.

21. The display apparatus of claim 14, wherein the unit pixel comprises:
a first switching element connected to the N-th gate line, the M-th data line, and a first pixel electrode;
a second switching element connected to the N-th gate line, the M-th data line, and a second pixel electrode; and
a third switching element including a gate electrode connected to an N-th charge sharing gate line, a source electrode connected to a down capacitor, and a drain electrode connected to the second pixel electrode.

22. The display apparatus of claim 21, wherein the gate electrode of the second sensing switching element is connected to the N-th charge sharing gate line, wherein the N-th charge sharing gate line is connected to a Y-th gate line, wherein Y is a positive integer different from X.

23. The display apparatus of claim 22, wherein the N-th charge sharing gate line is connected to the Y-th gate line at a peripheral region of the touch screen panel.

24. The display apparatus of claim 14, wherein the touch determining part is disposed in the data driver.

25. A touch screen panel comprising:
a unit pixel connected to a first gate line and a data line; and
a light sensing part including,
a first sensing switching element, and
a second sensing switching element, wherein the first sensing switching element includes a gate electrode connected to the first gate line, a drain electrode connected to a read out line, and a source electrode, and wherein the second sensing switching element includes a gate electrode, a drain electrode connected to the source electrode of the first sensing element, and a source electrode connected to a second gate line, wherein the gate electrode of the second sensing switching element is connected to one of a reset voltage source, the second gate line, a third gate line, or a maintaining voltage source.
